(19) United States
(12) Patent Application Publication
(10) Pub. No.: US 2023/0338858 A1
(43) Pub. Date: Oct. 26, 2023

(54) SETTLING GAMING ESTABLISHMENT RETAIL PURCHASES

(71) Applicant: IGT, Las Vegas, NV (US)

(72) Inventors: Kevin Higgins, Reno, NV (US); Jeffery Shepherd, Reno, NV (US)

(21) Appl. No.: 18/215,431

(22) Filed: Jun. 28, 2023

Related U.S. Application Data
(63) Continuation of application No. 17/125,382, filed on Dec. 17, 2020.

(51) Int. Cl. A63F 13/792; A63F 13/85

(52) U.S. Cl. CPC A63F 13/792; A63F 13/85

(57) ABSTRACT

A system that enables a gaming establishment retail system to operate with a hotel system to utilize a hotel room folio to complete one or more purchases of goods and/or services from a retail establishment associated with a gaming establishment. Upon a subsequent event occurring in association with the hotel system, the hotel system operates with an external funding source to settle the hotel room folio using a designated payment instrument.

### PRIORITY CLAIM

This application is a continuation of, claims the benefit of and priority to U.S. patent application Ser. No. 17/125,382, filed on Dec. 17, 2020, the entire contents of which is incorporated by reference herein.

### BACKGROUND

In various embodiments, the systems and methods of the present disclosure operate to facilitate gaming establishment retail and entertainment purchases made in association with a gaming establishment fund management system to a hotel room folio and, responsive to an occurrence of a settlement event, utilize a payment instrument and a hotel payment system to pay off an amount of funds used to complete such gaming establishment retail and entertainment purchases.

Certain hotels enable guest to charge food and beverage activity to their hotel room by authenticating the charge via signing a form and entering their last name and room number (which prevents malicious charges against the guest's room). Certain hotels associated with gaming establishments, such as casino resorts, enable hotel guests to perform a similar activity, although customer friction is relatively higher compared to mobile payment solutions otherwise offered by the gaming establishment (or even using a credit card which does not require the same degree of authentication to use).

### BRIEF SUMMARY

In certain embodiments, the present disclosure relates to a system including a processor, and a memory device that stores a plurality of instructions. When executed by the processor responsive to an attempted retail purchase at a point-of-sale terminal, the instructions cause the processor to determine if an amount of funds to complete the attempted retail purchase are chargeable to a hotel room folio associated with a user. When executed by the processor responsive to the determination being that the amount of funds to complete the attempted retail purchase are chargeable to the hotel room folio associated with the user, the instructions cause the processor to communicate data which results in the point-of-sale terminal completing the attempted retail purchase, and communicate data associated with the amount of funds to a component of a hotel system. When executed by the processor responsive to the determination being that the amount of funds to complete the attempted retail purchase are not chargeable to the hotel room folio associated with the user, the instructions cause the processor to determine if a balance of a gaming establishment account associated with the user includes at least the amount of funds to complete the attempted retail purchase.

In certain embodiments, the present disclosure relates to a gaming establishment retail system including a processor, and a memory device that stores a plurality of instructions. When executed by the processor responsive to an occurrence of an anticipated retail purchase event, the instructions cause the processor to determine if any retail purchases occurring at any point-of-sale terminals associated with a gaming establishment are chargeable to a hotel room folio associated with a user. When executed by the processor responsive to the determination being that any retail purchases complying with a control are chargeable to the hotel room folio associated with the user and responsive to an attempted retail purchase at a point-of-sale terminal associated with the gaming establishment complying with the control, the instructions cause the processor to communicate data which results in the point-of-sale terminal completing the attempted retail purchase. When executed by the processor responsive to an occurrence of a settlement event, for each completed retail purchase, the instructions cause the processor to communicate data associated with an amount of funds of that retail purchase to a component of a hotel system.

In certain embodiments, the present disclosure relates to a method of operating a system. Responsive to an attempted retail purchase at a point-of-sale terminal, the method includes determining, by a processor, if an amount of funds to complete the attempted retail purchase are chargeable to a hotel room folio associated with a user. responsive to the determination being that the amount of funds to complete the attempted retail purchase are chargeable to the hotel room folio associated with the user, the method includes communicating data which results in the point-of-sale terminal completing the attempted retail purchase, and communicating data associated with the amount of funds to a component of a hotel system. Responsive to the determination being that the amount of funds to complete the attempted retail purchase are not chargeable to the hotel room folio associated with the user, the method includes determining, by the processor, if a balance of a gaming establishment account associated with the user includes at least the amount of funds to complete the attempted retail purchase.

Additional features are described herein, and will be apparent from the following Detailed Description and the figures.

### BRIEF DESCRIPTION OF THE SEVERAL VIEWS OF THE DRAWINGS

FIG. 1 is an example configuration of the architecture of a plurality of different components of the system of the present disclosure.

FIG. 2A is a flow chart of example process for operating a system which enables gaming establishment retail and entertainment purchases to be made in association with a hotel system.

FIG. 2B is a flow chart of an example process for operating a system which settles gaming establishment retail and entertainment purchases made in association with a gaming establishment patron settling a hotel room folio.

FIG. 3 is an example graphical user interface displayed in connection with a mobile device application and pertaining to a hotel room folio including funds used to make gaming establishment retail and entertainment purchases.

### DETAILED DESCRIPTION

In various embodiments, the systems and methods of the present disclosure enable a gaming establishment retail system to operate with a hotel system associated with a gaming establishment to utilize a hotel room folio to complete one or more purchases of goods and/or services from a retail establishment associated with the gaming establishment. In such embodiments, upon a subsequent event occurring in association with the hotel system, the hotel system operates with an external funding source to settle the hotel room folio using a designated payment instrument.

In certain embodiments, in association with a user checking into a hotel of a gaming establishment, a hotel system operates with a gaming establishment retail system to potentially enable the user to purchase goods and/or services at various touchpoints associated with the gaming establishment, wherein such purchases are charged to the user's hotel room folio. In such embodiments, rather than requiring the user to pay for goods and/or services with funds in a gaming establishment account, such as a gaming establishment retail account and/or a gaming establishment cashless wagering account, the systems and methods of the present disclosure enable the user to utilize the funds in such gaming establishment accounts for additional purposes, such as gambling at various gaming devices of the gaming establishment.

More specifically, in certain embodiments, upon an anticipated retail purchase event occurring in association with a user, such as a patron checking into a hotel of a gaming establishment or making a reservation to stay at the hotel, a hotel system operates with a gaming establishment retail system to determine whether any gaming establishment retail purchases may be charged to the hotel room folio of the user as well as any controls associated with such gaming establishment retail purchases. In these embodiments, upon an attempted retail transaction by the user at a point-of-sale terminal, the gaming establishment retail system determines how to complete, if at all, the attempted retail transaction. That is, the gaming establishment retail system determines, either individually or in conjunction with one or more other system components, whether the user's attempted gaming establishment retail purchases may be charged to the hotel room folio of the user. Responsive to a determination that the user is permitted to charge gaming establishment retail purchases to their hotel room folio (and in certain embodiments subject to one or more additional controls being satisfied), the gaming establishment retail system completes the attempted retail transaction and notifies the hotel system to charge the amount of the purchased goods and/or services to the user's hotel room folio. Such a configuration enables funds otherwise intended to be used for non-retail transactions to continue to be used for such non-retail transactions (e.g., funds used to purchase goods and/or services throughout a gaming establishment do not reduce the amount of funds a user otherwise has available for wagering on games of chance and/or sporting event outcomes to win lucrative awards).

In addition to freeing up the user's availability of funds within a gaming establishment, in various embodiments, in association with the user checking out of the hotel of the gaming establishment or otherwise requesting to settle one or more charges on their hotel room folio, the hotel system operates with the gaming establishment retail system to settle the amount of funds used to purchase goods and/or services using a designated payment instrument, such as a credit card. More specifically, in certain embodiments, upon a settlement event occurring in association with the user, the hotel system determines (or operates with the gaming establishment retail system to determine) an amount of funds charged to the user's hotel room to complete one or more gaming establishment retail transactions. The hotel system applies the determined amount of funds to the hotel room folio of the user which is then paid for as part of the payment of the user's hotel room folio using a dedicated payment instrument, such as a credit card the hotel system has on file. Such a configuration of charging gaming establishment retail purchases to a hotel room folio for a single total payment using a dedicated payment instrument, such as a credit card, eliminates repeatedly incurring transaction fees with each use of the designated payment instrument, thereby minimizing such transaction fees incurred. Moreover, such a configuration of employing one or more components of the gaming establishment retail system to facilitate the purchases of goods and/or services using funds initially charged to the user's hotel room folio and then charged to a payment instrument of the user overcomes various security concerns associated with cash-based retail transactions (e.g., protecting patrons carrying cash to retail establishments) and encourages patrons to participate in an alternative, non-cash-based option for the patron to purchase goods and/or services from a retail establishment, thereby expanding the cashless ecosystem certain gaming establishments strive for.

### System Accounts

In various embodiments, the present disclosure is directed to a gaming establishment fund management system including various components or sub-systems that are each associated with or otherwise maintain one or more electronic or virtual accounts. In these embodiments, the various accounts maintained for a user collectively form a resort or enterprise account (i.e., a gaming establishment fund management account) for the user. That is, the collection of cashless wagering accounts (e.g. cashless gaming establishment wagering wallets, cashless sports wagering wallets and/or cashless mobile wagering wallets) and gaming establishment retail accounts (e.g., gaming establishment retail wallets) associated with or otherwise maintained for a user, such as a player and/or retail patron, collectively form a resort or enterprise account (i.e., an integrated resort or gaming establishment fund management wallet) that the user may access to transfer funds and/or view balance information amongst the various accounts associated with or otherwise maintained for the user.

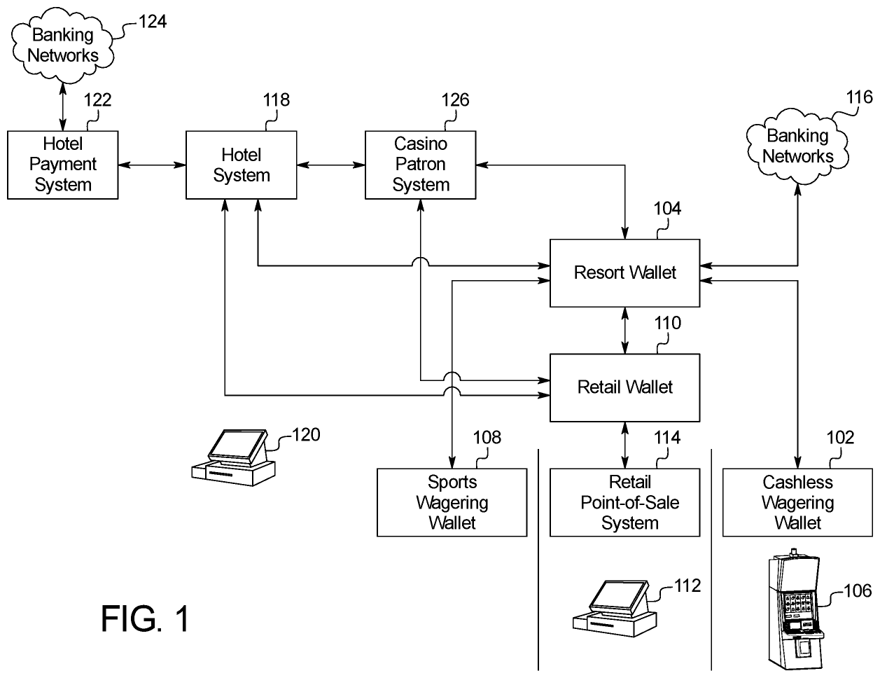

In various embodiments, the gaming establishment fund management system includes or is otherwise associated with one or more cashless wagering systems. Each cashless wagering system is associated with or otherwise maintain one or more cashless wagering accounts. In certain embodiments, the gaming establishment fund management system includes a first cashless wagering system that maintains a first cashless wagering account. In these embodiments, a user utilizes a mobile device application running on a mobile device and/or a physical instrument (e.g., a smart card or a user issued magnetic striped card which the user utilizes via inserting the card into a player tracking unit associated with an electronic gaming machine (“EGM”)) to facilitate the electronic transfer of any funds between this first cashless wagering account and a gaming device, such as a component of a gaming table and/or an EGM (including, but not limited to, a slot machine, a video poker machine, a video lottery terminal, a terminal associated with an electronic table game, a terminal associated with a live table game, a video keno machine, a video bingo machine and/or a sports betting terminal (that offers wagering games and/or sports betting opportunities)). For example, as seen in FIG. 1, the gaming establishment fund management system includes a first cashless wagering system (not shown) that maintains a cashless wagering wallet 102 (e.g., a first cashless wagering account) which is in communication with a resort wallet 104, wherein such components of the gaming establishment fund management system operate to transfer funds between the cashless wagering wallet and an EGM 106 or a gaming table component associated with a gaming table (not shown). In different examples, the system utilizes any suitable interface, such as, but not limited to, a mobile device running a mobile device application, a kiosk, an EGM, a service window displayed by a gaming device (e.g., a remote host controlled service window displayed by an EGM), a component of a gaming establishment patron management system, such as a player tracking unit, and/or a gaming establishment interface to enable a user, such as a player of the EGM or a player at a gaming table, access to this first cashless wagering account.

In certain embodiments, the gaming establishment fund management system additionally or alternatively includes or is otherwise associated with a second cashless wagering system that maintains a second cashless wagering account. In these embodiments, funds associated with the second cashless wagering account are utilized to place one or more sporting event wagers and/or wagers placed remote from an EGM and remote from a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and remote from a gaming table. For example, as seen in FIG. 1, the gaming establishment fund management system includes a second cashless wagering system (not shown) that maintains a sports wagering wallet 108 (e.g., a second cashless wagering account) which is in communication with the resort wallet 104, wherein such components of the gaming establishment fund management system operate to transfer funds between the sports wagering wallet and a gaming device configured to provide sports betting opportunities (not shown). In different embodiments, the system utilizes any suitable interface, such as, but not limited to, a mobile device running a mobile device application, a kiosk, an EGM, a service window displayed by a gaming device (e.g., a remote host controlled service window displayed by an EGM), a component of a gaming establishment patron management system, such as a player tracking unit, and/or a gaming establishment interface to enable a user, such as a player remote from the gaming establishment, which operates with one or more components of the gaming establishment fund management system, to enable a user, such as a player remote from the gaming establishment, access to this second cashless wagering account.

In various embodiments, in addition to or an alternative of maintaining one or more cashless wagering accounts via one or more cashless wagering systems, the gaming establishment fund management system includes or is otherwise associated with one or more gaming establishment retail wallet systems that each maintain one or more gaming establishment retail accounts. Such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a retail wallet 110 (e.g., a gaming establishment retail account) which is in communication with the resort wallet 104. In this example, to facilitate the transfer of funds from this gaming establishment retail account to an account associated with a retailer to purchase goods and/or services from the retailer, the system utilizes a retail wallet identity, such as a mobile device running a mobile device application, that interfaces with a point-of-sale terminal 112 of a retail point-of-sale system 114 of the retailer, and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a retailer.

It should be appreciated that in various embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In certain embodiments, the gaming establishment fund management system is in communication with one or more external funding sources which maintain one or more external accounts for the user. For example, as seen in FIG. 1, the gaming establishment fund management system that maintains the resort wallet 104 is in communication with a network of one or more banks or other financial institutions (i.e., the banking networks 116) which operate to electronically transfer funds to/from the user's accounts maintained at such banks or financial institutions to/from one or more of the accounts maintained by the gaming establishment fund management system. In certain embodiments, such external accounts include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts). It should be appreciated that while illustrated as the gaming establishment fund management system being in communication with one or more external funding sources, in different embodiments, any component or sub-system of the present disclosure can be in communication with one or more external funding sources. In different embodiments, the system utilizes any suitable interface, such as but not limited to, a mobile device running a mobile device application, a kiosk, an EGM, a service window displayed by a gaming device (e.g., a remote host controlled service window displayed by an EGM), a component of a gaming establishment patron management system, such as a player tracking unit, and/or a gaming establishment interface to facilitate the transfer of funds to/from a third-party account.

In certain embodiments, the gaming establishment retail system is in communication with one or more hotel systems which coordinate the reservations and stays of various patrons at a hotel associated with the gaming establishment. For example, as seen in FIG. 1, the gaming establishment retail system that enables the purchases of goods and/or services using funds in one or more gaming establishment accounts (e.g., a gaming establishment retail account and/or a cashless wagering account) is in communication with a hotel system 118 (including a hotel kiosk 120 and a hotel payment system 122 in communication with a banking network 124 of one or more banks or other financial institutions (that may be the same as or different from banking networks 116) that operate to electronically transfer funds to the hotel payment system to settle a user's hotel room folio with funds from the user's accounts maintained at such banks or financial institutions). As described herein, the hotel system and the gaming establishment retail system exchange data regarding a patron's check-in status with the hotel as well as purchases made using the gaming establishment retail account (which are chargeable to the user's hotel room folio). In these embodiments, the hotel system is also in communication with the gaming establishment fund management system (i.e., the resort wallet 104) to enable certain hotel charges to be monitored by and paid for with funds from one or more gaming establishment accounts maintained by the gaming establishment fund management system. It should be appreciated that any component or sub-system of the present disclosure can be in communication with one or more hotel systems.

In certain embodiments, the gaming establishment retail system and the hotel system are each in communication with one or more gaming establishment patron management systems. For example, as seen in FIG. 1, the gaming establishment retail system (i.e., retail wallet 110) and the hotel system (i.e., hotel system 118) are each in communication with one or more gaming establishment patron management systems (i.e., the casino patron system 126) that monitor activities at various points of contact associated with the gaming establishment and provides rewards, such as redeemable player tracking points, in association with such activities. offers lines of credits to gaming establishment patrons. It should be appreciated that any component or sub-system of the present disclosure can be in communication with one or more gaming establishment patron management systems.

In certain embodiments, the gaming establishment fund management system is in communication with one or more credit systems (not shown) which issue the user one or more lines of credit or markers. In these embodiments, the gaming establishment fund management system that maintains the resort wallet is in communication with a gaming establishment credit system to facilitate the activation of one or more lines of credit and the establishment of an amount of funds in the gaming establishment fund management account via such one or more lines of credits. In different embodiments, to facilitate a transfer of funds from the line of credit issued by the credit system to an EGM and/or a credit balance of a gaming table component associated with a gaming table (or to a cashless wagering account and then to a credit balance of an EGM and/or a credit balance of a gaming table component associated with a gaming table), the system utilizes any suitable interface, such as, but not limited to, a mobile device running a mobile device application, a kiosk, an EGM, a service window displayed by a gaming device (e.g., a remote host controlled service window displayed by an EGM), a component of a gaming establishment patron management system, such as a player tracking unit, and/or a gaming establishment interface to enable a user, such as a player of the EGM or a player at the gaming table, access to the issued line of credit. In different embodiments, any component or sub-system of the present disclosure can be in communication with one or more gaming establishment credit systems.

In certain embodiments, the gaming establishment credit system is in communication with one or more credit reporting/credit risk systems (not shown) which monitor and report on various accounts associated with the user. These credit reporting and risk systems monitor and report on a credit rating and status of one or more accounts maintained for the user at various funding sources, such as various financial institutions. It should be appreciated that any component or sub-system of the present disclosure can be in communication with one or more credit reporting/credit risk systems.

### Linking Hotel Folio to Gaming Establishment Retail Activity

In certain embodiments, the system of the present disclosure enables a user to activate charging purchases of goods and/or services to a hotel room folio for that user as part of the user checking into a hotel of the gaming establishment. In these embodiments, upon an anticipated retail purchase event occurring in association with the user checking into a hotel of a gaming establishment (or otherwise occurring in association with one or more other activities, such as the user making reservations for a room at the hotel of the gaming establishment or the user making one or more inputs to attempt to opt into such a feature), the hotel system operates with a gaming establishment retail system to determine whether or not to offer the user the ability to charges retail purchases to the user's hotel room folio and if so, any controls or conditions associated with such charges.

In certain such embodiments, when a user first checks into a hotel of a gaming establishment, such as via a user interface running on a hotel check-in desk workstation or a hotel check-in kiosk, the user will typically present a driver's license (or other form of identification) and a payment instrument, such as a credit card or debit card. The hotel system records this information such that the payment instrument may be charged at a later point in time to settle any outstanding charges (e.g., room service) on the hotel room folio at check-out. During this hotel check-in process, the hotel system communicates a notification of the user's arrival to a gaming establishment retail system and/or a gaming establishment patron management system (which notifies the gaming establishment retail system of the user's arrival).

In certain embodiments, if the gaming establishment retail system (and/or the gaming establishment patron management system, the gaming establishment fund management system or any components thereof) indicate to the hotel system that the user lacks an account maintained by that respective system, the hotel system enables the user to enroll or otherwise sign up for such an account. It should be appreciated that since the user is providing certain information, such as information obtained from the user's driver license or other government issued identification, to the hotel system as part of the hotel check-in process, the hotel system is already in possession of certain information required by the gaming establishment retail system (and/or the gaming establishment patron management system). That is, by utilizing various information provided to a hotel system as part of a hotel check-in process, the system of the present disclosure streamlines the process, if applicable, of opening various accounts for the user thereby saving users time in not having to rekey in or reprovide the same information multiple times and reducing potential errors in different data sets maintained by different systems (i.e., not requiring the duplication of providing the same information multiple times reduces the risks in inconsistencies in such information) thereby increasing operational efficiencies of the different systems employed. In one such embodiment, in association with the opening of the account, the user is provided a physical instrument associated with the gaming establishment patron management system account (e.g., hotel personnel providing the user a player tracking card) and/or the gaming establishment account. In another such embodiment, the user is provided a code to activate their account and/or download a mobile identification (e.g., a mobile pass representing a player tracking card) via logging into a mobile device application associated with the gaming establishment or logging into a website associated with the gaming establishment. In another such embodiment, the user is sent an SMS text (and/or e-mail) informing the user how to activate their account and/or download a mobile identification via logging into a mobile device application associated with the gaming establishment or logging into a website associated with the gaming establishment. In certain embodiments, in addition to enabling a user to enroll in one or more gaming establishment accounts during the hotel check-in process, the system enables a user, such as a retail patron and/or player of a gaming establishment device, to enroll or otherwise sign up for such accounts via other avenues. For example, the gaming establishment retail system enables a user to enroll or otherwise sign up for a gaming establishment retail account via picking up a retail account card at various locations, such as shops, throughout the gaming establishment, via a mobile application running on a mobile device, via a point-of-sale terminal, via an EGM, via a kiosk and/or via adding a retail account to an existing patron account, such as a player tracking account.

In certain embodiments, following a determination that the user checking into the hotel is associated with a gaming establishment retail account, the hotel system and/or the gaming establishment retail system make various determinations regarding the creditworthiness of the user and whether or not to extend hotel credit to the user to purchase goods and/or services associated with the gaming establishment. That is, as part of the hotel check-in process, one or more components of the system of the present disclosure determine whether to enable a user to charge the purchase price of goods and/or services to the user's hotel room folio and if so, an amount which may be charged to the user's hotel room folio for such purchases.

In one such embodiment, the hotel system and/or the gaming establishment retail system operates with a credit reporting/credit risk system to perform a credit check and determine whether or not to activate the retail purchase to hotel room folio feature and/or how much hotel credit, if any, to authorize to the user to make retail purchases charged to the user's hotel room folio. In another such embodiment, the hotel system and/or the gaming establishment retail system additionally or alternatively operates with credit reporting/credit risk system to determine if the user has any outstanding lines of credit (at that gaming establishment and/or at another gaming establishment), wherein the presence or absence of such lines of credit factor into whether or not to activate the retail purchase to hotel room folio feature and/or how much hotel credit, if any, to authorize to the user to make retail purchases charged to the user's hotel room folio. In another such embodiment, the hotel system and/or the gaming establishment retail system additionally or alternatively operates with a gaming establishment employee management system to validate that the user checking into the hotel is not a hotel employee and/or a gaming establishment employee, wherein such a determination factors into whether or not to activate the retail purchase to hotel room folio feature and/or how much hotel credit, if any, to authorize to the user to make retail purchases charged to the user's hotel room folio. In another such embodiment, the hotel system and/or the gaming establishment retail system additionally or alternatively operates with a responsible gaming system to validate that the user checking into the hotel has not previously opted out of participating in the gaming establishment hotel credit program (via any suitable interface, such as a gaming establishment website, a mobile device application or a gaming establishment interface, such as a front desk), wherein such a determination factors into whether or not to activate the retail purchase to hotel room folio feature and/or how much hotel credit, if any, to authorize to the user to make retail purchases charged to the user's hotel room folio.

In certain embodiments, in addition to operating with zero, one or more systems to determine whether or not to activate the retail purchase to hotel room folio feature and/or how much hotel credit, if any, to authorize to the user to make retail purchases charged to the user's hotel room folio, the system employs gaming establishment operator oversight in such determinations. In these embodiments, for certain users, such as users with a questionable credit history (whom the gaming establishment may be reluctant to extend hotel credit to without prior gaming establishment operator approval) and/or users with excellent credit history (whom the gaming establishment may want to extend additional hotel credit to beyond the amount of approved hotel credit and/or whom the amount of approved hotel credit exceeds a threshold), the hotel system and/or the gaming establishment retail system requires gaming establishment operator approval.

In various embodiments, as part of the determination of whether or not to activate the retail purchase to hotel room folio feature and/or how much hotel credit, if any, to authorize to the user to make retail purchases charged to the user's hotel room folio, the hotel system and/or the gaming establishment retail system associate zero, one or more controls with any hotel credit to authorize to the user to make retail purchases charged to the user's hotel room folio. That is, in certain embodiments, the hotel system and/or the gaming establishment retail system determines one or more conditions which must be satisfied to complete a retail purchase wherein the purchase price is allocated to the user's hotel room folio.

In one such embodiment, the hotel system and/or the gaming establishment retail system associates a control dictating that certain types of retail purchases can be charged to a user's hotel room folio while other types of retail purchases cannot be charged to the user's hotel room folio. For example, one or more components of the gaming establishment system associate a control permitting a first category of purchases, such as food and beverage purchases, to be charged to a user's hotel stay, but preventing a second category of purchases, such as clothing retail outlets and entertainment related charges, to be charged to a user's hotel stay.

In another such embodiment, the hotel system and/or the gaming establishment retail system additionally or alternatively associates a control based on one or more limits (e.g., daily limits or hotel stay visit limits) on the amount that may be charged to a user's hotel room folio. In different embodiments, these limits are based on a user's identity (e.g., different player tracking rankings have different limits), an amount of an outstanding authorization placed on the user's credit card or debit card when the user checked into the hotel, one or more rules established by the user and/or one or more rules established by the gaming establishment operator.

In another such embodiment, the hotel system and/or the gaming establishment retail system additionally or alternatively associates a control based on an amount of funds in one or more gaming establishment accounts maintained for the user. For example, the gaming establishment retail system permits all purchases to be charged against the user's cashless wagering account until a low watermark is encountered in the user's cashless wagering account. In this example, once the amount of funds in the user's cashless wagering account is lower than the low watermark, all subsequent retail purchases are charged to the user's hotel room folio to preserve the funds in the user's cashless wagering account.

In another such embodiment, the hotel system and/or the gaming establishment retail system additionally or alternatively associates a control based on a current rate of consumption of the funds in one or more gaming establishment accounts maintained for the user. For example, in an effort to maintain funds in a gaming establishment account, such as a cashless wagering account, the hotel system and/or the gaming establishment retail system utilizes a control based on gaming spend trends vs retail spend trends.

In various embodiments, if the hotel system and/or the gaming establishment retail system determines not to authorize the user to make retail purchases charged to the user's hotel room folio, the hotel system and/or the gaming establishment retail system notifies the user, if applicable, regarding the different ways the user may pay for retail purchases utilizing funding options provided by the gaming establishment fund management system. For example, the hotel system and/or the gaming establishment retail system notifies the user, via one or more of a message displayed on a user interface running on a hotel check-in desk workstation (which is then conveyed to the user by a hotel employee), a message displayed on a user interface of a hotel check-in kiosk, a displayed message at a gaming establishment device (e.g., an EGM or a retail point-of-sale terminal), a displayed message on a television or tablet in the user's hotel room, a virtual assistant in the user's hotel room, an email, a SMS or text message, a notification displayed by a mobile device application, and/or a phone call that the user may purchase goods and/or services at various retail touchpoints throughout the gaming establishment using the funds in one or more gaming establishment accounts maintained for the user, such as the gaming establishment retail account maintained for the user and/or the gaming establishment cashless wagering account maintained for the user.

On the other hand, if the hotel system and/or the gaming establishment retail system determines to authorize the user to make retail purchases charged to the user's hotel room folio, then following any required acknowledgement by the user of any required terms and conditions associated with extending hotel credit to the user to purchase goods and/or services associated with the gaming establishment, the hotel system and/or the gaming establishment retail system notifies the user, if applicable, regarding the different ways the user may pay for retail purchases utilizing hotel credit or utilizing funding options provided by the gaming establishment fund management system. For example, the hotel system and/or the gaming establishment retail system notifies the user, via one or more of a message displayed on a user interface running on a hotel check-in desk workstation (which is then conveyed to the user by a hotel employee), a message displayed on a user interface of a hotel check-in kiosk, a displayed message at a gaming establishment device (e.g., an EGM or a retail point-of-sale terminal), a displayed message on a television or tablet in the user's hotel room, a virtual assistant in the user's hotel room, an email, a SMS or text message, a notification displayed by a mobile device application, and/or a phone call that the user may purchase goods and/or services at various retail touchpoints throughout the gaming establishment using any of an amount of hotel credit extended to the user (with the understanding that such hotel credit will be settled at a future point in time) or the funds in one or more gaming establishment accounts maintained for the user, such as the gaming establishment retail account maintained for the user and/or the gaming establishment cashless wagering account maintained for the user.

Charging Retail Purchases to Hotel Room Folio

In addition to authorizing the user to make retail purchases charged to the user's hotel room folio, in certain embodiments, upon the presentation of a retail wallet identity (e.g., a physical card associated with the gaming establishment retail account, a mobile device running a mobile device application associated with the gaming establishment retail account, or a mobile device that presents an identity associated with the player or the player's gaming establishment retail account) at an applicable point-of-sale terminal of a retail point-of-sale system within or otherwise associated with the gaming establishment for the purchase of goods and/or services, the system determines whether or not to complete the attempted retail purchase. For example, when a purchase of goods and/or services is attempted to be made with funds charged to the hotel system using a mobile device application at a point-of-sale terminal, the mobile device application prompts the player to cause the mobile device to engage the point-of-sale terminal, such as prompting the player to tap the mobile device to a designated portion of the point-of-sale terminal (or otherwise moving the mobile device to within a designated distance of a designated location of the point-of-sale terminal). Such engagement initiates a pairing or linkage between the mobile device and the point-of-sale terminal (or a component of a gaming establishment fund management system located inside the point-of-sale terminal (i.e., a component of the point-of-sale terminal)), wherein the pairing or linkage between the mobile device and the point-of-sale terminal occurs via one or more applications being run or executed on the mobile device. In this example, after such engagement, the mobile device application communicates, via a wireless communication protocol (including, but not limited to: Bluetooth™, Bluetooth™ Low Energy (“BLE”), one or more cellular communication standards (e.g., 3G, 4G, 5G, LTE), one or more Wi-Fi compatible standards, and one or more short range communication protocols (e.g., a near field communication (“NFC”) protocol), data associated with the retail wallet identity to the point-of-sale terminal to facilitate the potential purchase of goods and/or services. In various embodiments, in addition to or alternative from attempting to make purchases of goods and/or services with funds charged to the hotel system at a point-of-sale terminal, the system of the present disclosure enables a user to attempt to make purchases of goods and/or services with funds charged to the hotel system via any suitable interface, such as a user interface of an EGM, a user interface of a gaming table component associated with a gaming table, a kiosk, a mobile device application being executed by a mobile device, a service window displayed by a gaming device (e.g., a remote host controlled service window displayed by an EGM), and/or a gaming establishment interface (e.g., a casino desk). It should be appreciated that certain gaming establishment policies may require the user to approve such retail transactions by entering a personal identification number (“PIN”) via the user interface, providing a signature and/or presenting a biometric identifier to the employed user interface.

In various embodiments, upon receiving data or information regarding the retail wallet identity, the retail point-of-sale system communicates with the gaming establishment retail system which determines if the user is a hotel guest authorized to make retail purchases charged to the user's hotel room folio (and/or communicates with one or more other systems, such as the hotel system, to request such information). Upon the determination that the user is a hotel guest authorized to make retail purchases charged to the user's hotel room folio, the gaming establishment retail system (and/or another system, such as the hotel system) determines if the attempted purchase complies with any controls associated with the user's access to funds. For example, if one or more components of the gaming establishment system associate a control permitting food and beverage purchases to be charged to a user's hotel stay, but preventing clothing retail outlets and entertainment related charges to be charged to a user's hotel stay, the gaming establishment retail system determines if the attempted purchase is for a food and beverage purchase (in which case the purchase complies with the associated control) or for a retail and entertainment purchase (in which case the purchase violates the associated control). In another example, if one or more components of the gaming establishment system associate a control limiting the total amount of purchases to be charged to a user's hotel stay per day, the gaming establishment retail system determines if the attempted purchase would cause the total amount of purchases charged to the user's hotel room folio for that day to remain below the limit (in which case the purchase complies with the associated control) or reach or exceed the limit (in which case the purchase violates the associated control).

If the gaming establishment retail system (and/or another system, such as the hotel system) determines that the attempted purchase cannot be completed, such as because the user is not a hotel guest or the attempted purchase, if completed, would violate one or more associated controls, the gaming establishment retail system (and/or another system, such as the hotel system) denies the sale transaction of the goods and/or services using funds to be charged to the user's hotel room folio and communicates such a denial to the retail point-of-sale system which rejects the attempted purchase. It should be appreciated that if the gaming establishment retail system denies the sale transaction of the goods and/or services using funds to be charged to the user's hotel room folio, the user may still be able to complete the transaction with funds in one or more gaming establishment accounts maintained for the user, such as the user's gaming establishment retail account and/or the user's cashless wagering account. In certain such embodiments, if purchasing goods and/or services using funds charged to the user's hotel room folio is not an option for the user, the gaming establishment retail system automatically determines if one or more gaming establishment accounts have adequate funds to cover the cost of the attempted purchase and if so, operates with zero, one or more components of the gaming establishment fund management system to transfer such funds to the retail establishment to complete the purchase of the goods and/or services. In other such embodiments, if purchasing goods and/or services using funds charged to the user's hotel room folio is not an option for the user, the gaming establishment retail system notifies the user and then enables the user to attempt to complete the purchase using another form of payment (including, but not limited to, transferring funds from one or more gaming establishment accounts to cover the cost of the attempted purchase). It should be further appreciated that in certain embodiments, the hotel system and/or the gaming establishment retail system determines the manner to complete an attempted retail transaction (i.e., using funds charged to the user's hotel room folio versus using funds in one or more gaming establishment accounts maintained by the gaming establishment fund management system) and proceeds to attempt to complete the retail transaction utilizing the system determined manner.

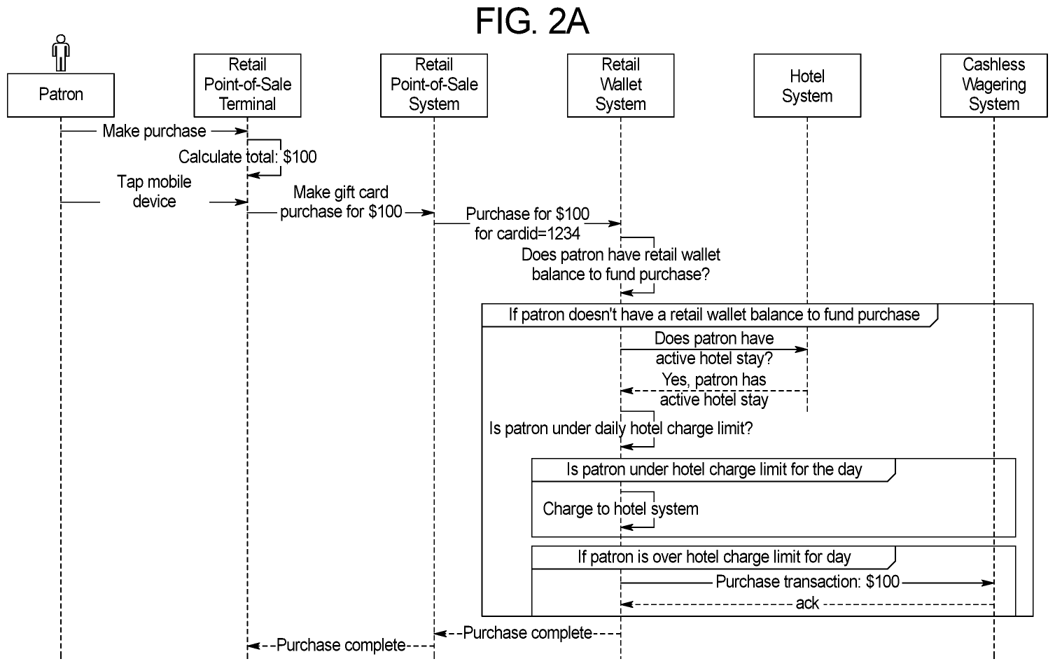

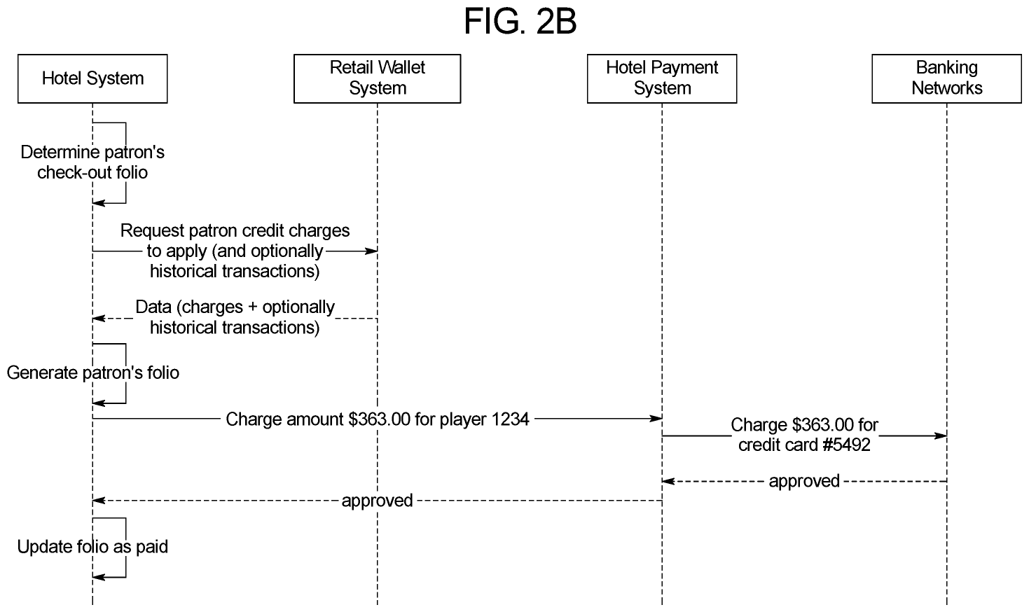

On the other hand, upon the determination that the attempted purchase complies with any controls associated with the user's access to funds, the gaming establishment retail system (and/or another system, such as the hotel system) authorizes the sale of the goods and/or services and communicates an approval to the retail point-of-sale system which completes the retail transaction. Accordingly, as seen in the example of FIG. 2A, a plurality of different components of the system of the present disclosure (i.e., a retail point-of-sale terminal, a retail point-of-sale system, a gaming establishment retail system, a hotel system and a cashless wagering system) interact with each other to potentially enable a user to purchase goods and/or services using an amount of funds associated with a user's hotel room folio (to be subsequently settled in association with that user checking out of a hotel of the gaming establishment). As such, in these embodiments, the hotel system operates with the gaming establishment retail system and zero, one or more other systems to facilitate, subject to any employed controls, the purchase of goods and/or services with an amount fronted by or otherwise charged to the hotel system. Such a configuration enables funds otherwise intended to be used for non-retail transactions to continue to be used for such non-retail transactions (e.g., funds used to purchase goods and/or services throughout a gaming establishment do not reduce the amount of funds a user otherwise has available for wagering on games of chance and/or sporting event outcomes to win lucrative awards). Moreover, rather than repeatedly incurring transaction fees with each use of a designated payment instrument, such as a credit card, to pay for goods and/or services procured throughout a gaming establishment, such a configuration minimize such transaction fees, thereby enabling gaming establishment operators to pass such savings onto gaming establishment patrons. In addition to benefiting both retail patrons and retailers via the reduction of transaction fees associated with certain retail purchase transactions and in view of the various security concerns (e.g., protecting gaming establishment patrons carrying cash to retail establishments) associated with cash-based retail transactions, the system of the present disclosure encourages retail patrons to participate in an alternative, non-cash-based option for the retail patron to purchase goods and/or services from a retail establishment, thereby expanding the cashless ecosystem certain gaming establishments strive for.

Following the authorization of the sale of the goods and/or services, the gaming establishment retail system notifies the hotel system information regarding the purchase, including, but not limited to, the amount of the purchase, the date of the purchase, the location of the purchase, and the items purchased. In one such embodiment, purchases made using hotel credit are tracked by the gaming establishment retail system when they are made and the hotel system reconciles all transactions associated with the user's current visit when the user checks out of the hotel. In another such embodiment, the gaming establishment retail system notifies the hotel system immediately when a retail purchase is performed. In another such embodiment, the hotel system periodically synchronizes retail purchase transactions with the gaming establishment retail system, such as every hour, or every 24 hours.

### Settling Retail Purchases Charged to Hotel Room Folio

In various embodiments, following a user making one or more retail purchases with an amount of funds charged to the user's hotel room folio, the system monitors for an occurrence of a retail purchase settlement event. In these embodiments, upon a retail purchase settlement event, such as a patron checking out of a hotel of a gaming establishment, the system operates with one or more gaming establishment components to pay for the retail purchases charged to the user's hotel folio using a designated payment instrument, such as the credit card or debit card. In certain embodiments, when a user attempts to check-out of a hotel of a gaming establishment (or otherwise settle the amount of retail purchases made in association with a hotel system), the hotel system operates with the gaming establishment retail system to determine if the user made any retail purchases charged to the user's hotel folio. If the gaming establishment retail system determines that the user made one or more retail purchases charged to the user's hotel folio, the gaming establishment retail system operates with the hotel system to enable the user to pay for such retail purchases as part of the payment of the user's hotel room folio. In certain other embodiments wherein the hotel system was previously notified of any retail purchases charged to the user's hotel folio, the hotel system looks up the transactions recorded and enables the user to pay for such retail purchases as part of the payment of the user's hotel room folio. Accordingly, to reduce the number of payment instrument transactions occurring during a user's stay at a gaming establishment hotel (which reduces transaction fees incurred) and further free up funds for other activities within the gaming establishment, the system of the present disclosure incorporates the settlement of one or more retail purchases with the settlement of an outstanding gaming establishment hotel liability to provide a more streamlined and efficient process relating to retail purchases made at (or otherwise associated) with a gaming establishment.

Specifically, in certain embodiments, following a user making one or more retail purchases charged to the user's hotel folio, the system monitors for an occurrence of a retail purchase settlement event, such as in the form of the user checking out of a hotel of the gaming establishment. In these embodiments, upon the user attempting to check-out of the hotel (or upon an automatic checking out process of the hotel on the user's check-out day), the hotel system communicates one or more messages to the gaming establishment retail system to log the user into the gaming establishment retail system (if necessary) and obtain information regarding the retail purchase liability of the user. That is, at one or more designated intervals, such as periodically, whenever a retail purchase is charged to the user's hotel folio, and/or as part of the process of determining the user's hotel room folio (for checking out of the hotel and/or to present to the user the current hotel room folio if they were to presently check out of the hotel), the hotel system contacts the gaming establishment retail system to determine information (or otherwise confirm previously communication information) about retail purchases made that need to be settled with the hotel system.

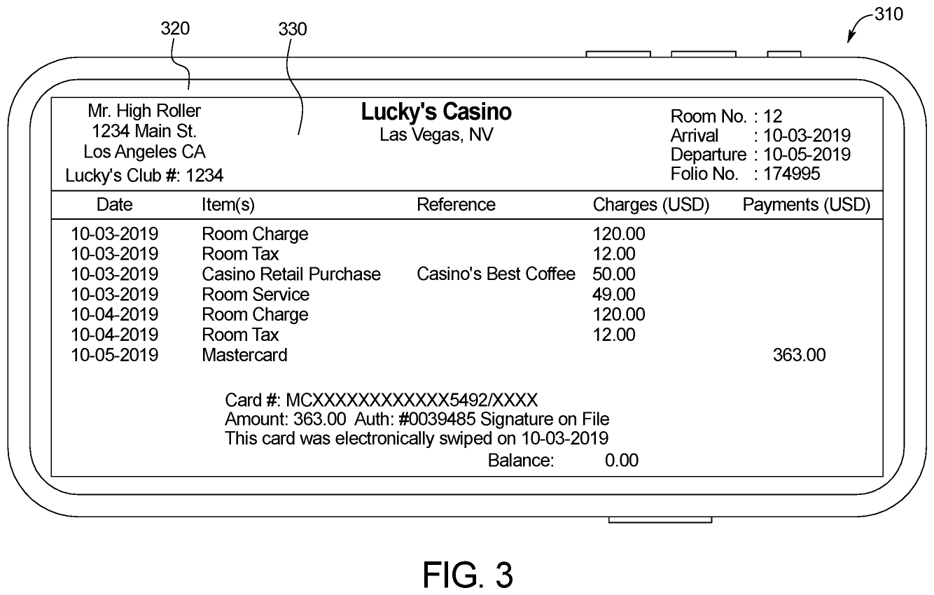

Following the gaming establishment retail system providing the hotel system information regarding any retail purchases made that need to be applied to the user's hotel room folio (and/or following the hotel system accessing one or more databases to retrieve information regarding any retail purchases previously charged to the user's hotel room folio), the hotel system compiles a current amount owed including charges pertaining to the user's retail activities charged to the user's hotel room and the user's non-retail activities charged to the user's hotel room. In such embodiments, the hotel room folio includes various line items regarding the hotel activities undertaken by the user independent of any retail purchases associated with the gaming establishment retail system (e.g., hotel room charges, room tax charges, hotel resort fees, hotel room service fees, hotel food & beverage fees, and any sales taxes) as well as various line items regarding the retail purchases associated with the gaming establishment retail system (e.g., a type of retail purchase, the amount of the purchase, the date of the purchase, the location of the purchase, the item purchased, and/or an amount of any retail purchase fees or convenience charges). For example, as seen in FIG. 3, the gaming establishment retail system operates with the hotel system to include retail purchase transactions on the hotel room folio which is then accessible, in this example, by a mobile device application 320 of a mobile device 310 to enable the user to view a hotel room folio 330 including charges pertaining to the user's activities associated with the gaming establishment retail system and the user's activities not associated with the gaming establishment retail system.

After determining the current amount owed including retail transactions charged to the user's hotel folio, the hotel system (or a component of the hotel system, such as a hotel payment system) attempts to pay off the charges owed on the hotel folio with the payment instrument provided at hotel check-in, such as a credit card or debit card. If the hotel system (or the component of the hotel system, such as the hotel payment system) is unable to pay off the amount owed on the hotel room folio with the payment instrument (e.g., the amount owed on the hotel room folio exceeds the credit limit on the user's credit card), the hotel system communicates one or more payment denied messages to the gaming establishment retail system. In certain embodiments, the hotel system and/or the gaming establishment retail system then attempts to utilize funds from other accounts of the gaming establishment fund management system to pay off such retail transactions charged to the hotel room folio and/or such non-retail transactions charged to the hotel room folio. On the other hand, if the hotel system (or the component of the hotel system, such as the hotel payment system) successfully pays off the amount owed on the hotel room folio with the payment instrument, the hotel system notifies the gaming establishment retail system which updates one or more databases to reflect that the retail purchases charged to the user's hotel folio have been paid (which may be factored into one or more future decisions regarding whether to make this feature available to the user for subsequent visits to the hotel of the gaming establishment). Accordingly, as seen in the example of FIG. 2B, a plurality of different components of the system of the present disclosure (i.e., a hotel system, a gaming establishment retail system, and a hotel payment system) interact with each other and an external banking network to potentially settle gaming establishment retail purchases charged to the hotel room folio in association with that user checking out of a hotel of the gaming establishment.

It should be appreciated that any functionality or process of the present disclosure may be implemented via one or more servers (associated with or independent of any component of any system disclosed herein), one or more gaming establishment devices (e.g., a gaming device such as an EGM or a non-gaming device such as a point-of-sale terminal), one or more components of a gaming establishment device (such as a component of a gaming establishment management system supported by or otherwise located inside the gaming establishment device), or a mobile device application. For example, while certain data or information of the present disclosure is explained as being communicated from a gaming establishment device, or a component associated with a gaming establishment device to a mobile device via one or more wireless communication protocols, such data or information may additionally or alternatively be communicated from one or more servers to a mobile device via one or more wireless communication protocols. Accordingly: (i) while certain functions, features or processes are described herein as being performed by a gaming establishment device or a component associated with a gaming establishment device, such functions, features or processes may alternatively be performed by one or more servers, or one or more mobile device applications, or one or more gaming establishment components, (ii) while certain functions, features or processes are described herein as being performed by one or more mobile device applications, such functions, features or processes may alternatively be performed by one or more servers, one or more gaming establishment devices, one or more components of a gaming establishment device, or one or more gaming establishment components, (iii) while certain functions, features or processes are described herein as being performed by one or more servers, such functions, features or processes may alternatively be performed by one or more gaming establishment devices, one or more components of a gaming establishment device, one or more mobile device applications, or one or more gaming establishment components, and (iv) while certain functions, features or processes are described herein as being performed by one or more gaming establishment components, such functions, features or processes may alternatively be performed by one or more gaming establishment devices, one or more components of a gaming establishment device, or one or more servers.

In certain embodiments, the above-described embodiments of the present disclosure may be implemented in accordance with or in conjunction with zero, one or more components of a gaming establishment fund management system (e.g., a cashless wagering system or a gaming establishment retail system), zero, one or more components of a gaming establishment patron management system, zero, one or more components of a hotel system (e.g., a hotel check-in kiosk or a hotel check-in desk workstation), zero, one or more components of a retail point-of-sale system and/or zero, one or more gaming establishment devices. In these embodiments, such components of the gaming establishment fund management system, the gaming establishment patron management system, the hotel system, the retail point-of-sale system and/or the gaming establishment device each include a controller including at least one processor. The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the gaming establishment fund management system, the component of the gaming establishment patron management system, the component of the hotel system, the component of the retail point-of-sale system and/or the gaming establishment device; (3) accessing memory to configure or reconfigure parameters in the memory according to indicia read from the component of the gaming establishment fund management system, the component of the gaming establishment patron management system, the component of the hotel system, the component of the retail point-of-sale system and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the gaming establishment fund management system, the component of the gaming establishment patron management system, the component of the hotel system, the component of the retail point-of-sale system and/or the gaming establishment device, while in other embodiments, at least one component of the controller resides outside of the housing of the component of the gaming establishment fund management system, the component of the gaming establishment patron management system, the component of the hotel system, the component of the retail point-of-sale system and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the gaming establishment fund management system, the component of the gaming establishment patron management system, the component of the hotel system, the component of the retail point-of-sale system and/or the gaming establishment device disclosed herein. In certain embodiments, the at least one memory device resides within the housing of the component of the gaming establishment fund management system, the component of the gaming establishment patron management system, the component of the hotel system, the component of the retail point-of-sale system and/or the gaming establishment device, while in other embodiments at least one component of the at least one memory device resides outside of the housing of the component of the gaming establishment fund management system, the component of the gaming establishment patron management system, the component of the hotel system, the component of the retail point-of-sale system and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the gaming establishment fund management system, the component of the gaming establishment patron management system, the component of the hotel system, the component of the retail point-of-sale system and/or the gaming establishment device; (2) associations between configuration indicia read from a component of the gaming establishment fund management system with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the gaming establishment fund management system, the component of the gaming establishment patron management system, the component of the hotel system, the component of the retail point-of-sale system and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the player's computer, partly on the player's computer, as a stand-alone software package, partly on the player's computer and partly on a remote computer or entirely on the remote computer or server. In the latter scenario, the remote computer may be connected to the player's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the gaming establishment fund management system, the component of the gaming establishment patron management system, the component of the hotel system, the component of the retail point-of-sale system and/or the gaming establishment device to control the component of the gaming establishment fund management system, the component of the gaming establishment patron management system, the component of the hotel system, the component of the retail point-of-sale system and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a retail patron uses such a removable memory device in a component of the gaming establishment fund management system to implement at least part of the present disclosure. In other embodiments, part or all of the program code and/or the operating data is downloaded to the at least one memory device of the component of the gaming establishment fund management system, the component of the gaming establishment patron management system, the component of the hotel system, the component of the retail point-of-sale system and/or the gaming establishment device through any suitable data network described above (such as an Internet or intranet).

The at least one memory device also stores a plurality of device drivers. Examples of different types of device drivers include device drivers for the component of the gaming establishment fund management system, the component of the gaming establishment patron management system, the component of the hotel system, the component of the retail point-of-sale system and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the gaming establishment fund management system, the component of the gaming establishment patron management system, the component of the hotel system, the component of the retail point-of-sale system and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the gaming establishment fund management system, the component of the gaming establishment patron management system, the component of the hotel system, the component of the retail point-of-sale system and/or the gaming establishment device loads the new device driver from the at least one memory device to enable communication with the new device. For instance, one type of card reader in the component of the gaming establishment fund management system, the component of the gaming establishment patron management system, the component of the hotel system, the component of the retail point-of-sale system and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the gaming establishment fund management system, the component of the gaming establishment patron management system, the component of the hotel system, the component of the retail point-of-sale system and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the gaming establishment fund management system, the component of the gaming establishment patron management system, the component of the hotel system, the component of the retail point-of-sale system and/or the gaming establishment device. In various embodiments, the display devices serve as digital glass configured to aspects of the gaming establishment in which the component of the gaming establishment fund management system, the component of the gaming establishment patron management system, the component of the hotel system, the component of the retail point-of-sale system and/or the gaming establishment device is located. In various embodiments, the component of the gaming establishment fund management system, the component of the gaming establishment patron management system, the component of the hotel system, the component of the retail point-of-sale system and/or the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the component of the gaming establishment fund management system, the component of the gaming establishment patron management system, the component of the hotel system, the component of the retail point-of-sale system and/or the gaming establishment device receives an actuation, the component of the gaming establishment fund management system, the component of the gaming establishment patron management system, the component of the hotel system, the component of the retail point-of-sale system and/or the gaming establishment device causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the component of the gaming establishment fund management system, the component of the gaming establishment patron management system, the component of the hotel system, the component of the retail point-of-sale system and/or the gaming establishment device provides dynamic sounds coupled with attractive multimedia images displayed on one or more of the display devices to provide an audio-visual representation or to otherwise display full-motion video with sound to attract players to the component of the gaming establishment fund management system, the component of the gaming establishment patron management system, the component of the hotel system, the component of the retail point-of-sale system and/or the gaming establishment device. In certain embodiments, the component of the gaming establishment fund management system, the component of the gaming establishment patron management system, the component of the hotel system, the component of the retail point-of-sale system and/or the gaming establishment device displays a sequence of audio and/or visual attraction messages during idle periods to attract potential players to the component of the gaming establishment fund management system, the component of the gaming establishment patron management system, the component of the hotel system, the component of the retail point-of-sale system and/or the gaming establishment device. The videos may be customized to provide any appropriate information.

The at least one input device may include any suitable device that enables an input signal to be produced and received by the at least one processor of the component of the gaming establishment fund management system, the component of the gaming establishment patron management system, the component of the hotel system, the component of the retail point-of-sale system and/or the gaming establishment device. In one embodiment, the at least one input device includes a payment device configured to communicate with the at least one processor of the component of the gaming establishment fund management system, the component of the gaming establishment patron management system, the component of the hotel system, the component of the retail point-of-sale system and/or the gaming establishment device to fund the component of the gaming establishment fund management system, the component of the gaming establishment patron management system, the component of the hotel system, the component of the retail point-of-sale system and/or the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the component of the gaming establishment fund management system, the component of the gaming establishment patron management system, the component of the hotel system, the component of the retail point-of-sale system and/or the gaming establishment device to be funded via an electronic funds transfer, such as a transfer of funds from a bank account. In another embodiment, the component of the gaming establishment fund management system, the component of the gaming establishment patron management system, the component of the hotel system, the component of the retail point-of-sale system and/or the gaming establishment device includes a payment device configured to communicate with a mobile device of a player, such as a mobile phone, a radio frequency identification tag, or any other suitable wired or wireless device, to retrieve relevant information associated with that player to fund the component of the gaming establishment fund management system, the component of the gaming establishment patron management system, the component of the hotel system, the component of the retail point-of-sale system and/or the gaming establishment device. When the component of the gaming establishment fund management system, the component of the gaming establishment patron management system, the component of the hotel system, the component of the retail point-of-sale system and/or the gaming establishment device is funded, the at least one processor determines the amount of funds entered and displays the corresponding amount.

In various embodiments, the at least one input device includes a plurality of buttons that are programmable by the component of the gaming establishment fund management system, the component of the gaming establishment patron management system, the component of the hotel system, the component of the retail point-of-sale system and/or the gaming establishment device operator to, when actuated, cause the component of the gaming establishment fund management system, the component of the gaming establishment patron management system, the component of the hotel system, the component of the retail point-of-sale system and/or the gaming establishment device to perform particular functions. For instance, such buttons may be hard keys, programmable soft keys, or icons icon displayed on a display device of the component of the gaming establishment fund management system, the component of the gaming establishment patron management system, the component of the hotel system, the component of the retail point-of-sale system and/or the gaming establishment device that are actuatable via a touch screen of the component of the gaming establishment fund management system, the component of the gaming establishment patron management system, the component of the hotel system, the component of the retail point-of-sale system and/or the gaming establishment device or via use of a suitable input device of the component of the gaming establishment fund management system, the component of the gaming establishment patron management system, the component of the hotel system, the component of the retail point-of-sale system and/or the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the component of the gaming establishment fund management system, the component of the gaming establishment patron management system, the component of the hotel system, the component of the retail point-of-sale system and/or the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the gaming establishment fund management system, the component of the gaming establishment patron management system, the component of the hotel system, the component of the retail point-of-sale system and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the gaming establishment fund management system, the component of the gaming establishment patron management system, the component of the hotel system, the component of the retail point-of-sale system and/or the gaming establishment device, such as one or more rechargeable power sources (e.g., rechargeable batteries) located at the component of the gaming establishment fund management system, the component of the gaming establishment patron management system, the component of the hotel system, the component of the retail point-of-sale system and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the gaming establishment fund management system, the component of the gaming establishment patron management system, the component of the hotel system, the component of the retail point-of-sale system and/or the gaming establishment device; detecting the presence and/or identity of various persons (e.g., players, casino employees, etc.), devices (e.g., user input devices), and/or systems within a predetermined proximity to the component of the gaming establishment fund management system, the component of the gaming establishment patron management system, the component of the hotel system, the component of the retail point-of-sale system and/or the gaming establishment device.

The at least one data preservation component is configured to detect or sense one or more events and/or conditions that, for example, may result in damage to the component of the gaming establishment fund management system, the component of the gaming establishment patron management system, the component of the hotel system, the component of the retail point-of-sale system and/or the gaming establishment device and/or that may result in loss of information associated with the component of the gaming establishment fund management system, the component of the gaming establishment patron management system, the component of the hotel system, the component of the retail point-of-sale system and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected player movements and/or gestures to determine appropriate player input information relating to the detected player movements and/or gestures. For example, in one embodiment, the at least one motion/gesture analysis and interpretation component is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source enables the component of the gaming establishment fund management system, the component of the gaming establishment patron management system, the component of the hotel system, the component of the retail point-of-sale system and/or the gaming establishment device to operate in a mobile environment.

The at least one geolocation module is configured to acquire geolocation information from one or more remote sources and use the acquired geolocation information to determine information relating to a relative and/or absolute position of the component of the gaming establishment fund management system, the component of the gaming establishment patron management system, the component of the hotel system, the component of the retail point-of-sale system and/or the gaming establishment device. For example, in one implementation, the at least one geolocation module is configured to receive GPS signal information for use in determining the position or location of the component of the gaming establishment fund management system, the component of the gaming establishment patron management system, the component of the hotel system, the component of the retail point-of-sale system and/or the gaming establishment device. In another implementation, the at least one geolocation module is configured to receive multiple wireless signals from multiple remote devices (e.g., component of the gaming establishment fund management system, the gaming establishment patron management system, the hotel system, the retail point-of-sale system and/or the gaming establishment devices, servers, wireless access points, etc.) and use the signal information to compute position/location information relating to the position or location of the component of the gaming establishment fund management system, the component of the gaming establishment patron management system, the component of the hotel system, the component of the retail point-of-sale system and/or the gaming establishment device.

The at least one user identification module is configured to determine the identity of the current user or current owner of the component of the gaming establishment fund management system, the component of the gaming establishment patron management system, the component of the hotel system, the component of the retail point-of-sale system and/or the gaming establishment device. For example, in one embodiment, the current user is required to perform a login process at the component of the gaming establishment fund management system, the component of the gaming establishment patron management system, the component of the hotel system, the component of the retail point-of-sale system and/or the gaming establishment device in order to access one or more features. Alternatively, the component of the gaming establishment fund management system, the component of the gaming establishment patron management system, the component of the hotel system, the component of the retail point-of-sale system and/or the gaming establishment device is configured to automatically determine the identity of the current user based on one or more external signals, such as an RFID tag or badge worn by the current user and that provides a wireless signal to the component of the gaming establishment fund management system, the component of the gaming establishment patron management system, the component of the hotel system, the component of the retail point-of-sale system and/or the gaming establishment device that is used to determine the identity of the current user. In at least one embodiment, various security features are incorporated into the component of the gaming establishment fund management system, the component of the gaming establishment patron management system, the component of the hotel system, the component of the retail point-of-sale system and/or the gaming establishment device to prevent unauthorized users from accessing confidential or sensitive information.

The at least one information filtering module is configured to perform filtering (e.g., based on specified criteria) of selected information to be displayed at one or more displays of the component of the gaming establishment fund management system, the component of the gaming establishment patron management system, the component of the hotel system, the component of the retail point-of-sale system and/or the gaming establishment device.

In various embodiments, the component of the gaming establishment fund management system, the component of the gaming establishment patron management system, the component of the hotel system, the component of the retail point-of-sale system and/or the gaming establishment device includes a plurality of communication ports configured to enable the at least one processor of the component of the gaming establishment fund management system, the component of the gaming establishment patron management system, the component of the hotel system, the component of the retail point-of-sale system and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the gaming establishment fund management system, the component of the gaming establishment patron management system, the component of the hotel system, the component of the retail point-of-sale system and/or the gaming establishment device has a support structure, housing, or cabinet that provides support for a plurality of the input devices and the output devices of the component of the gaming establishment fund management system, the component of the gaming establishment patron management system, the component of the hotel system, the component of the retail point-of-sale system and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor, cause the processor to:
responsive to an attempted retail purchase at a point-of-sale terminal, determine, at least partially based on data maintained independent of any component of any hotel system, if an amount of funds to complete the attempted retail purchase are chargeable to a hotel room folio associated with a user,
responsive to the determination being that the amount of funds to complete the attempted retail purchase are chargeable to the hotel room folio associated with the user:
independent of any component of any hotel system authorizing the attempted retail purchase, communicate data which results in the point-of-sale terminal completing the attempted retail purchase as a first non-cash-based retail transaction, and
following a determination to complete the attempted retail purchase as the first non-cash-based retail transaction, communicate data associated with the amount of funds to a component of a hotel system, and
responsive to the determination being that the amount of funds to complete the attempted retail purchase are not chargeable to the hotel room folio associated with the user, determine if a balance of a gaming establishment account associated with the user includes at least the amount of funds to complete the attempted retail purchase as a second, different non-cash-based retail transaction, the determination occurring independent of any component of any hotel system.

2. The system of claim 1, wherein the determination of if the amount of funds to complete the attempted retail purchase are chargeable to the hotel room folio associated with the user comprises a determination of if the attempted retail purchase complies with any controls to complete the attempted retail purchase.

3. The system of claim 2, wherein a control to complete the attempted retail purchase comprises at least one of an identification of the user, a category of the attempted retail purchase, a limit on the amount of funds, the balance of the gaming establishment account associated with the user, and a spending rate of the gaming establishment account associated with the user.

4. The system of claim 1, wherein when executed by the processor, the instructions cause the processor to determine if the amount of funds to complete the attempted retail purchase are chargeable to the hotel room folio at least partially based on data maintained by and received from the component of the hotel system.

5. The system of claim 1, wherein when executed by the processor, the instructions cause the processor to communicate data associated with the amount of funds to the component of the hotel system responsive to an occurrence of a settlement event.

6. The system of claim 5, wherein the settlement event comprises the user checking out of a hotel associated with the component of the hotel system.

7. The system of claim 1, wherein when executed by the processor, the instructions cause the processor to determine if any retail purchases are chargeable to the hotel room folio associated with the user responsive to an occurrence of an anticipated retail purchase event.

8. The system of claim 7, wherein the anticipated retail purchase event comprises a completion of a reservation for a room at a hotel associated with the component of the hotel system.

9. The system of claim 7, wherein the anticipated retail purchase event comprises the user checking into a hotel associated with the component of the hotel system.

10. A gaming establishment retail system comprising:
a processor; and
a memory device that stores a plurality of instructions that, when executed by the processor, cause the processor to:
responsive to an occurrence of an anticipated retail purchase event, determine if any retail purchases occurring at any point-of-sale terminals associated with a gaming establishment are chargeable to a hotel room folio associated with a user,
responsive to the determination being that any retail purchases complying with a control are chargeable to the hotel room folio associated with the user and responsive to an attempted retail purchase at a point-of-sale terminal associated with the gaming establishment complying with the control, independent of any component of any hotel system authorizing the attempted retail purchase, communicate data which results in the point-of-sale terminal completing the attempted retail purchase as a non-cash-based retail transaction, and
responsive to an occurrence of a settlement event, for each completed retail purchase, communicate data associated with an amount of funds of that retail purchase to a component of the hotel system.

11. The gaming establishment retail system of claim 10, wherein the control comprises at least one of an identification of the user, a category of each attempted retail purchase, a limit on the amount of funds, the balance of a gaming establishment account associated with the user, and a spending rate of the gaming establishment account associated with the user.

12. A method of operating a system, the method comprising:
responsive to an attempted retail purchase at a point-of-sale terminal, determining, by a processor and at least partially based on data maintained independent of any component of any hotel system, if an amount of funds to complete the attempted retail purchase are chargeable to a hotel room folio associated with a user,
responsive to the determination being that the amount of funds to complete the attempted retail purchase are chargeable to the hotel room folio associated with the user:
independent of any component of any hotel system authorizing the attempted retail purchase, communicating data which results in the point-of-sale terminal completing the attempted retail purchase as a first non-cash-based retail transaction, and
following a determination to complete the attempted retail purchase as the first non-cash-based retail transaction, communicating data associated with the amount of funds to a component of a hotel system, and
responsive to the determination being that the amount of funds to complete the attempted retail purchase are not chargeable to the hotel room folio associated with the user, determining, by the processor, if a balance of a gaming establishment account associated with the user includes at least the amount of funds to complete the attempted retail purchase as a second, different non-cash-based retail transaction, the determination occurring independent of any component of the hotel system.

13. The method of claim 12, wherein the determination of if the amount of funds to complete the attempted retail purchase are chargeable to the hotel room folio associated with the user comprises a determination of if the attempted retail purchase complies with any controls to complete the attempted retail purchase.

14. The method of claim 13, wherein a control to complete the attempted retail purchase comprises at least one of an identification of the user, a category of the attempted retail purchase, a limit on the amount of funds, the balance of the gaming establishment account associated with the user, and a spending rate of the gaming establishment account associated with the user.

15. The method of claim 12, further comprising determining, by the processor, if the amount of funds to complete the attempted retail purchase are chargeable to the hotel room folio at least partially based on data maintained by and received from the component of the hotel system.

16. The method of claim 12, further comprising communicating data associated with the amount of funds to the component of the hotel system responsive to an occurrence of a settlement event.

17. The method of claim 16, wherein the settlement event comprises the user checking out of a hotel associated with the component of the hotel system.

18. The method of claim 12, further comprising determining, by the processor, if any retail purchases are chargeable to the hotel room folio associated with the user responsive to an occurrence of an anticipated retail purchase event.

19. The method of claim 18, wherein the anticipated retail purchase event comprises a completion of a reservation for a room at a hotel associated with the component of the hotel system.

20. The method of claim 18, wherein the anticipated retail purchase event comprises the user checking into a hotel associated with the component of the hotel system.
